(19) United States
(12) Patent Application Publication
(10) Pub. No.: US 2012/0008591 A1
(43) Pub. Date: Jan. 12, 2012

(54) RADIO COMMUNICATION CONTROL METHOD, RADIO BASE STATION APPARATUS AND USER APPARATUS

(75) Inventors: Nobuhiko Miki, Kanagawa (JP); Mamoru Sawahashi, Kanagawa (JP)

(73) Assignee: NTT DOCOMO, INC., Tokyo (JP)

(21) Appl. No.: 13/145,447

(22) PCT Filed: Jan. 20, 2010
(86) PCT No.: PCT/JP2010/050587

§ 371 Date: Sep. 20, 2011

(30) Foreign Application Priority Data
Jan. 21, 2009 (JP) 2009-011346
Aug. 6, 2009 (JP) 2009-183692

(51) Int. Cl. H04W 72/04

(52) U.S. Cl. 370/330

(57) ABSTRACT

When a first traffic type to which a predetermined pattern of radio resources are allocated periodically and a second traffic type to which available radio resources are sequentially allocated are mixed and multiplexed, the present invention improves communication quality of the first and second traffic types. In a radio communication system in which a first traffic type to which a predetermined pattern of radio resources are periodically allocated and a second traffic type to which available radio resources are sequentially allocated are mixed and multiplexed, the first traffic type to which the predetermined pattern of frequency resources are allocated at fixed intervals is user-multiplexed using CDM and the second traffic type to which resource blocks are sequentially allocated starting from those in good states is multiplexed using FDM and TDM as defined in LTE.

### TECHNICAL FIELD

The present invention relates to a radio communication control method, radio base station apparatus and user apparatus in which a first traffic type to which a predetermined pattern of radio resources are periodically allocated and a second traffic type to which available radio resources are sequentially allocated are mixed, multiplexed and transmitted through a downlink.

### BACKGROUND ART

The WCDMA standardization organization 3GPP is studying and establishing specifications for a communication scheme which becomes a successor of the Wideband Code Division Multiple Access (WCDMA) scheme, High Speed Downlink Packet Access (HSDPA) scheme, High Speed Uplink Packet Access (HSUPA) scheme or the like, that is, Long Term Evolution (LTE). As radio access schemes in LTE, an Orthogonal Frequency Division Multiplexing Access (OFDMA) scheme and Single-Carrier Frequency Division Multiple Access (SC-FDMA) scheme are defined for a downlink and uplink respectively.

The OFDMA scheme is a multicarrier transmission scheme according to which a frequency band is divided into a plurality of narrow frequency bands (subcarriers) and data is transmitted by being carried on each subcarrier. By densely arranging subcarriers so as to be orthogonal to each other on the frequency axis, it can be expected that high-speed transmission will be realized and frequency utilization efficiency will be improved.

The SC-FDMA scheme is a single carrier transmission scheme according to which a frequency band is allocated to different terminals and frequency bands differing among a plurality of terminals are used for transmission. Since this scheme can not only simply and effectively reduce interference between terminals but also reduce fluctuations of transmission power, the scheme is desirable from the standpoint of reducing power consumption of terminals and expanding coverage or the like.

LTE uses both time scheduling and frequency scheduling to allocate resources to user apparatuses in order to improve the utilization efficiency of radio resources compared to the current level. Radio resources are allocated in units of a block having a size of a certain bandwidth (e.g., 180 kHz) and a certain period (e.g., 1.0 ms). This unit block is called “resource block (RB). By instantaneously allocating one or more resource blocks to users in the frequency axis direction and time axis direction in better channel conditions, it is possible to improve data transmission efficiency (throughput) of the entire system. A base station determines which resource block is allocated to which user and this processing is called “scheduling.”

An LTE system allocates one or more resource blocks to a mobile station on both downlink and uplink. The base station determines to which of a plurality of mobile stations resource blocks are allocated in subframe (1 ms in LTE) units. The base station transmits a shared channel on a downlink using one or more resource blocks to a mobile station selected through scheduling. On the uplink, the selected mobile station transmits a shared channel using one or more resource blocks to the base station. The shared channel is a PUSCH (Physical Uplink Shared Channel) for the uplink and a PDSCH (Physical Downlink Shared Channel) for the downlink.

Unlike the third generation mobile communication system which is optimized for a channel switching type network, LTE is optimized so as to support a PS (packet switch: packet switching type) service. On the other hand, to support end-to-end Qos, at least speech data (VoIP) must realize wireless quality as good as that of speech transmission using a channel switching network. For this reason, LTE allocates radio resources for speech data in a manner similar to channel switching. To be more specific, a predetermined pattern of radio resources are allocated to speech data periodically (at fixed time intervals) and radio resources are thereby allocated with higher priority than data communication (e.g., see Non-Patent Document 1).

### Citation List

Non-Patent Literature

Non-Patent Literature 1: 3GPP, TS36.300 V1.0.0

### SUMMARY OF INVENTION

### Technical Problem

However, when fixed radio resources are periodically allocated to speech data, the effect of frequency domain scheduling is not obtained, and therefore there is a possibility that speech quality may deteriorate. Furthermore, regarding not only speech data but also data of a traffic type to which a predetermined pattern of radio resources are periodically allocated, the effect of frequency domain scheduling is not obtained in the same way as speech data, and therefore there is a demand for improvement of communication quality.

The present invention has been implemented in view of the above problems and it is an object of the present invention to provide, when a first traffic type to which a predetermined pattern of radio resources are periodically allocated and a second traffic type to which available radio resources are sequentially allocated are mixed and multiplexed, a radio communication control method, radio base station apparatus and user apparatus that can improve communication quality of the first and second traffic types.

### Solution to Problem

According to a first aspect of the present invention, a radio communication control method includes a step of allocating first radio resources to first traffic type data at a predetermined period and in a predetermined pattern and sequentially allocating available second radio resources to second traffic type data, a step of code division multiplexing the first traffic type data among a plurality of users and frequency division multiplexing and time division multiplexing the second traffic type data among a plurality of users and a step of transmitting the multiplexed data.

Since the first traffic type data to which radio resources are allocated at a predetermined period and in a predetermined pattern are multiplexed by applying a code division multiplexing scheme, it is possible to improve communication quality by smoothing interference for the first traffic type in which the effect of frequency domain scheduling is not obtained.

According to a second aspect of the present invention, a radio communication control method includes a step of separating the first and second traffic type data from a received signal received through an uplink based on information on the first and second radio resources and a step of despreading, when the separated received data is a first traffic type, the received data using a despreading code corresponding to the spreading code assigned to a transmission user of the received data and decoding the received data.

Furthermore, a third aspect of the present invention includes a step of receiving first resource allocation information on radio resources allocated to first traffic type data at a predetermined period and in a predetermined pattern, and spreading code information assigned to users through a downlink, a step of sequentially receiving second resource allocation information of available radio resources sequentially allocated to second traffic type data through a downlink, a step of spread spectrum modulating, when data transmitted through an uplink is the first traffic type, the first traffic type data based on the spreading code information and mapping the spread spectrum modulated signal at a predetermined position of the frequency domain based on the first resource allocation information and a step of mapping, when data transmitted through the uplink is the second traffic type, the second traffic type data at a predetermined position of the frequency domain based on the second resource allocation information.

Furthermore, a fourth aspect of the present invention includes a step of separating, when the data received through the downlink is the first traffic type, the received data based on the first resource allocation information and despreading the separated data based on the spreading code information and demodulating the data and a step of separating, when the data received through the downlink is the second traffic type, the received data based on the second resource allocation information.

### Technical Advantage of the Invention

According to the present invention, when a first traffic type to which a predetermined pattern of radio resources are periodically allocated and a second traffic type to which available radio resources are sequentially allocated are mixed and multiplexed, it is possible to improve communication quality of the first and second traffic types.

### BRIEF DESCRIPTION OF DRAWINGS

FIG. 1 is a conceptual diagram of data multiplexing using different multiplexing schemes for speech data and transmission data;

FIG. 2 is a diagram illustrating fixed radio resources allocated to a user carrying out speech communication;

FIG. 3 is a diagram illustrating a concept of allocation of fixed radio resources to speech communication users according to LTE;

FIG. 4 is a schematic diagram of a mobile communication system having a mobile station and base station apparatus according to an embodiment of the present invention;

FIG. 5 is a function block diagram of the base station apparatus according to the embodiment of the present invention;

FIG. 6 is a function block diagram of the transmission processing system in the baseband signal processing section of the radio base station;

FIG. 7 is a function block diagram of the reception processing system in the baseband signal processing section of the radio base station;

FIG. 8 is a function block diagram of the mobile station according to the embodiment of the present invention;

FIG. 9 is a function block diagram of the reception processing system of the baseband signal processing section of the mobile station;

FIG. 10 is a function block diagram of the transmission processing system of the baseband signal processing section of the mobile station; and

FIG. 11 is a diagram illustrating a sequence from start to end of data communication/speech communication.

### DESCRIPTION OF EMBODIMENT

Hereinafter, embodiments of the present invention will be described in detail with reference to the accompanying drawings. First, the basic concept will be described. The LTE system can employ a method whereby a predetermined pattern of frequency resources are allocated to fixed-speed and low-rate data such as speech conversation (VoIP) and videophone (first traffic type) preferentially and at fixed intervals, while resource blocks are sequentially allocated to data other than the first traffic type (second traffic type) starting from those in good states among available resource blocks.

The present embodiment applies a code division multiplexing scheme (CDM) in addition to a frequency division multiplexing scheme (FDM) and time division multiplexing scheme (TDM) to the first traffic type (not limited to speech conversation or videophone) to which a predetermined pattern of frequency resources are allocated at fixed intervals and user-multiplexes the data, and applies FDM and TDM, as defined in LTE, to the second traffic type to which resource blocks are sequentially allocated starting from those in good states and multiplexes the data.

Thus, by switching between the data multiplexing schemes according to the traffic type, it is possible to improve communication quality also for the first traffic type in which the effect of frequency domain scheduling is not obtained.

The first traffic type can also be said to be data to which a predetermined pattern of frequency resources are preferentially allocated at fixed time intervals up to a predetermined number of subframes ahead. The first traffic type typically includes speech data. The second traffic type can also be said to be data in which radio resources are preferentially allocated to users having instantaneously high radio propagation quality through time/frequency domain scheduling. Speech data will be described below as an example of the first traffic type, but the present invention does not limit the first traffic type to speech communication.

Furthermore, CDM generally refers to a scheme according to which different spreading codes (spreading code 1, spreading code 2, spreading code 3 . . . ) are assigned to a plurality of different users using the same frequency band, user data are spread spectrum modulated using the spreading code assigned to each user and the user data are multiplexed in the same frequency band and transmitted. FDM generally refers to a scheme according to which different frequencies (f1, f2, f3 . . . ) are assigned to different users and the user data are multiplexed in the frequency domain and transmitted. TDM refers to a scheme according to which one frequency f0 is divided into a plurality of time slots (T1, T2, T3 . . . ) for a plurality of users, multiplexed in the time domain and transmitted.

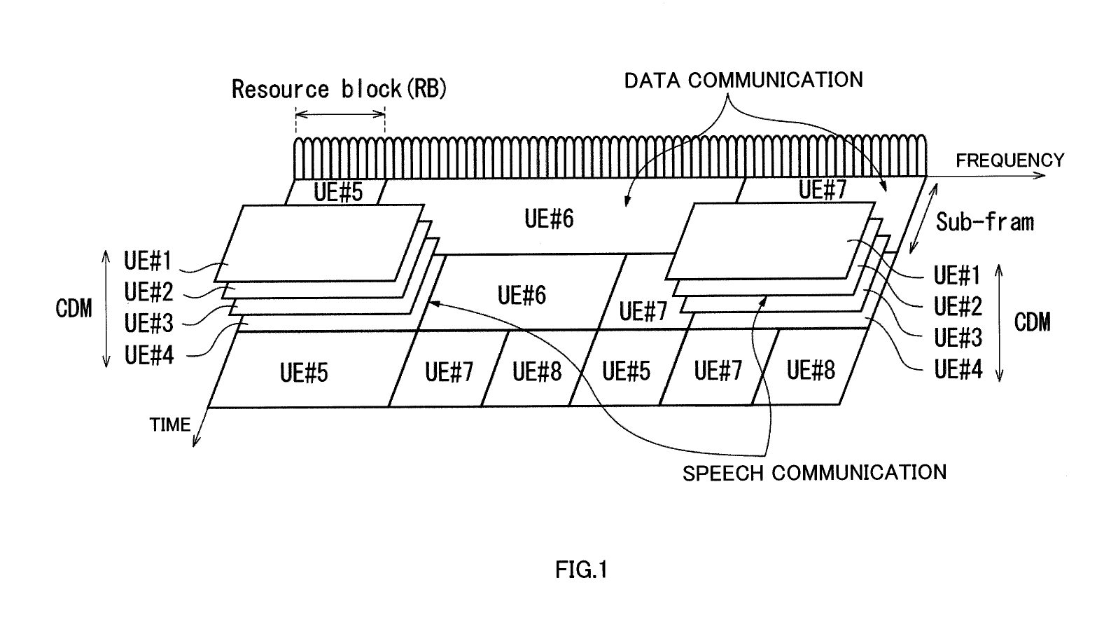

FIG. 1 is a conceptual diagram of data multiplexing which applies different multiplexing schemes to speech data of speech conversation and transmission data of data communication. FIG. 1 schematically shows a situation in which radio resources (frequency, time, spreading code) are allocated to a plurality of users #1 to #8. A radio resource is comprised of a resource block made up of a certain number of continuous subcarriers in the frequency axis direction and a certain number of symbols in the time domain. Furthermore, in radio resources (frequency, time) allocated to speech communication, speech data of a plurality of users is spread spectrum modulated using each spreading code assigned to each user and multiplexed. That is, a plurality of users are user-multiplexed with the same radio resource.

FIG. 1 shows a situation in which some users #1 to #4 are carrying out speech communication and other users #5 to #8 are carrying out data communication (hereinafter, data communication does not include speech communication (first traffic type) unless specified otherwise). A predetermined pattern of radio resources are periodically allocated to users #1 to #4 carrying out speech communication and different spreading codes are further assigned to users #1 to #4.

Speech data of users #1 to #4 are spread spectrum modulated using the respective spreading codes assigned to users #1 to #4 and are multiplexed with frequency resources (resource blocks) allocated for speech communication.

On the other hand, unallocated radio resources after allocation of radio resources for speech communication are preferentially allocated to users #5 to #8 carrying out data communication and having high radio propagation quality.

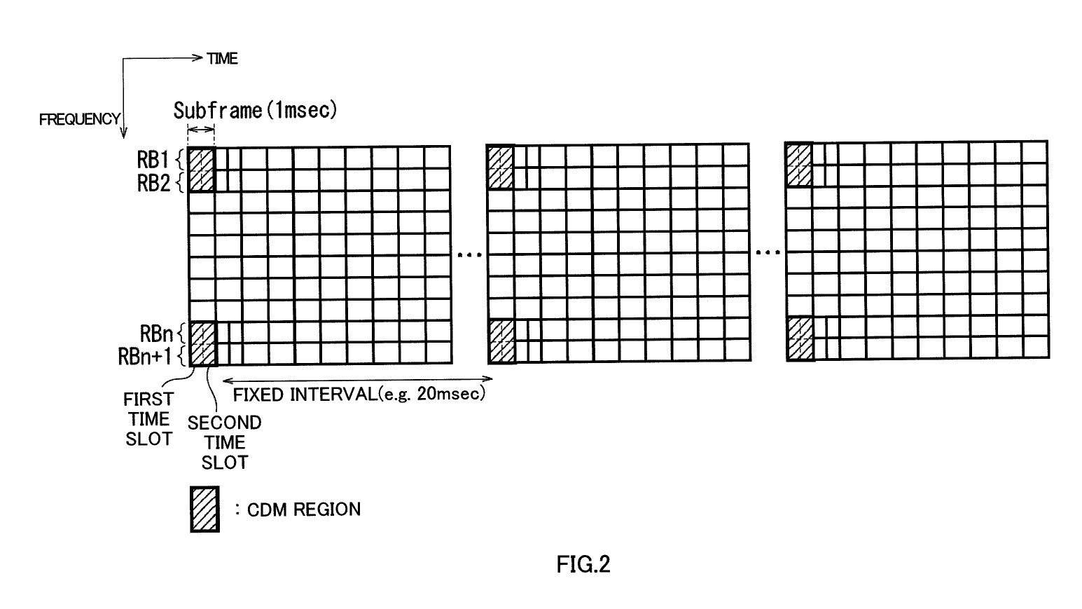

FIG. 2 is a diagram illustrating radio resources allocated to users carrying out speech communication. Shaded areas in the figure show radio resources allocated to users carrying out speech communication. As shown in FIG. 2, a predetermined pattern of radio resources are allocated for speech communication at a predetermined period. In the example shown in FIG. 2, one radio resource is set in a size of 1 subframe×2 resource blocks and two fixed radio resources separated from each other in the frequency axis direction are allocated in 1 subframe. Radio resources for speech communication are repeatedly allocated to the same resource block with the same subframe width at a fixed time interval (e.g., 20 msec).

When there are a plurality of users who carry out speech communication for the same period, radio resources (not including spreading codes) in the same time and frequency domains are allocated to the plurality of users carrying out speech communication. A maximum number of users allocated to one fixed radio resource can be predetermined by taking the system capacity into consideration. Until the maximum number of users is exceeded, radio resources in the same time and frequency domains are allocated to users who newly request speech communication. When users exceeding the maximum number of users are allocated to the already allocated radio resources, some of radio resources allocated to data communication so far are reallocated for speech communication and the number of radio resources in the time and frequency domains for speech communication is increased.

As described above, channel-switching-like speech communication is realized by allocating a predetermined pattern of radio resources to speech communication (users) preferentially and at a predetermined period, and code-multiplexing the plurality of users. On the other hand, for users of data communication, unallocated radio resources are preferentially allocated to users having high radio propagation quality and multiplexed according to an FDM/TDM scheme.

When speech data of a plurality of users are code-multiplexed (multiplexing according to a CDM scheme), speech data pieces are spread spectrum modulated and overlapped on each other with the same radio resource without making any distinction between users having high radio propagation quality and users having low radio propagation quality. As a result, even when there are users having high transmission power, speech data of the users are spread within radio resources in the time and frequency domains, and interference with a neighboring cell is thereby smoothed.

When a predetermined pattern of radio resources are allocated at a certain period in this way, the effect of scheduling in the time and frequency domains cannot be expected, but it is possible to obtain an effect of smoothing interference by user-multiplexing according to a CDM scheme.

Furthermore, as shown in FIG. 1 and FIG. 2, although a pattern of allocating two frequency blocks (frequency resources) to a 1-subframe section is applied, one frequency block is made up of two resource blocks. Thus, speech data is transmitted using four resource blocks in the 1-subframe section. Therefore, quality improvement by a frequency diversity effect can be expected.

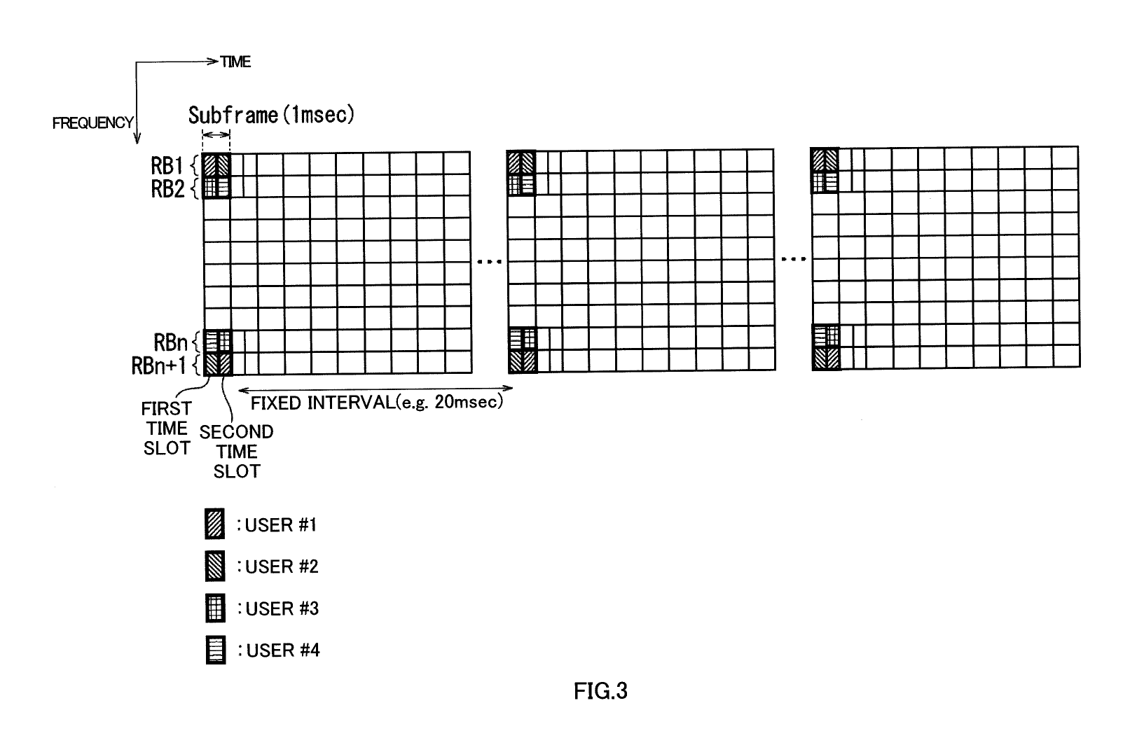

FIG. 3 shows a concept of allocation of radio resources to speech communication users according to LTE as a comparative example. 1 subframe is divided into a first time slot and a second time slot. The LTE system allocates a predetermined pattern of radio resources to speech communication and applies FDM/TDM as the user multiplexing scheme.

With reference to the example shown in FIG. 3, a specific example about the frequency diversity effect will be described. In each subframe section, first fixed radio resources made up of resource blocks RB1 and RB2, and second fixed radio resources made up of resource block RBn and RBn+1 located at a position separated from the first fixed radio resources in the frequency axis direction are fixedly secured. In the first fixed radio resources, a first time slot of the resource block RB1 is allocated to user #1, a second time slot of the resource block RB1 is allocated to user #2, a first time slot of the resource block RB2 is allocated to user #3 and a second time slot of the resource block RB2 is allocated to user #4. On the other hand, in the second fixed radio resources, a second time slot of the resource block RBn+l is allocated to user #1, a first time slot of the resource block RBn+1 is allocated to user #2, a first time slot of the resource block RBn is allocated to user #3 and a first time slot of the resource block RBn is allocated to user #4.

When attention is focused on user #1, speech communication is performed using two resource blocks of the resource block RB1 and the resource block RBn+1 in 1 subframe. For the other users, speech communication is performed using two resource blocks likewise.

Here, the frequency diversity effect of code multiplexing shown in FIG. 2 will be compared to that of code multiplexing shown in FIG. 3. According to the code multiplexing shown in FIG. 2, since speech data is transmitted using four resource blocks, its frequency diversity effect is large. On the other hand, according to the code multiplexing of the LTE system shown in FIG. 3, since speech data is transmitted using two resource blocks, its frequency diversity effect is reduced by half.

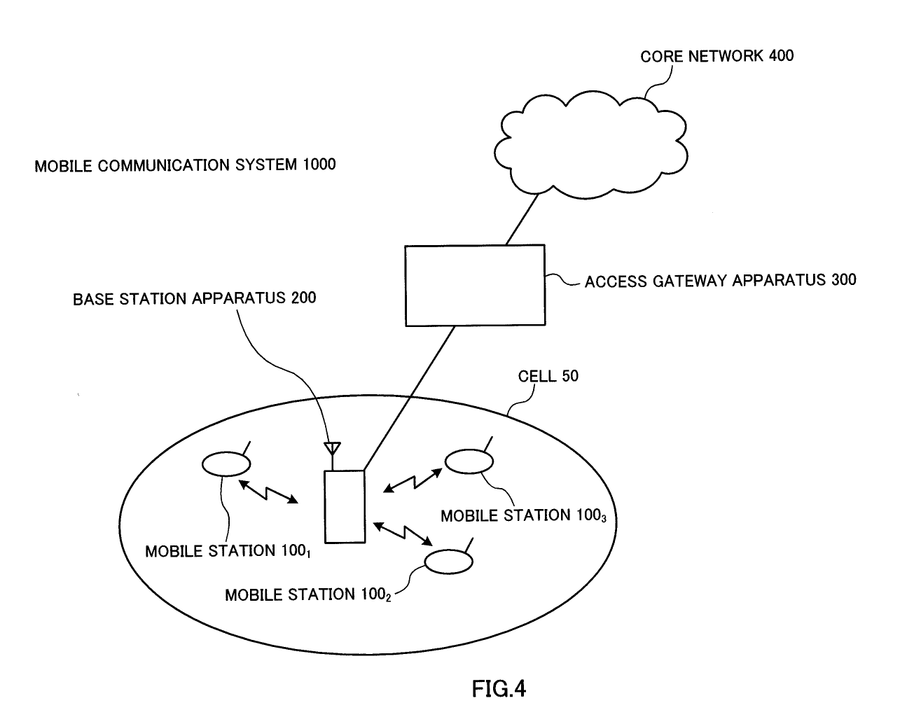

Hereinafter, embodiments of the present invention will be described in detail with reference to the accompanying drawings. A mobile communication system having a mobile station and a base station apparatus according to an embodiment of the present invention will be described with reference to FIG. 4.

A mobile communication system 1000 is based on an LTE system and has an improved user multiplexing scheme for speech communication on a downlink and an improved modulation scheme for speech communication on an uplink. The mobile communication system 1000 is provided with a base station apparatus 200 and a plurality of mobile stations 100 (100₁, 100₂, 100₃, 100ₙ, n is an integer n>0) that communicate with the base station apparatus 200. The base station apparatus 200 is connected to a higher station, for example, an access gateway apparatus 300 and the access gateway apparatus 300 is connected to a core network 400. The mobile station 100n is carrying out communication with the base station apparatus 200 in a cell 50 according to LTE. The access gateway apparatus 300 may also be called “MME/SGW (Mobility Management Entity/Serving Gateway).”

Since each mobile station (100₁, 100₂, 100₃, 100ₙ) has the same configuration and functions, this will be described as a mobile station 100n unless specified otherwise. For convenience of explanation, although the mobile station wirelessly communicates with the base station apparatus, in more general terms, the mobile terminal may be a user apparatus (UE: User Equipment) that also includes a fixed terminal.

As a radio access scheme, the mobile communication system 1000 employs OFDMA (orthogonal frequency division multiple access) for downlinks and SC-FDMA (single carrier-frequency division multiple access) for uplinks. As described above, OFDMA is a multicarrier transmission scheme according to which a frequency band is divided into a plurality of narrow frequency bands (subcarriers) and maps data to each subcarrier for carrying out communication. SC-FDMA is a single carrier transmission scheme according to which a system band is divided into bands composed of one or continuous resource blocks for different terminals and the plurality of terminals use bands different from each other to reduce interference between the terminals.

Here, a communication channel in the LTE system will be described. For downlinks, a physical downlink shared channel (PDSCH) shared among the mobile stations 100n and a physical downlink control channel (downlink L1/L2 control channel) are used. Through the physical downlink shared channel, user data, that is, signals of speech data and transmission data are transmitted. Furthermore, through the physical downlink control channel, scheduling information, spreading code information (limited to speech communication users) allocated to users, user ID for carrying out communication using the physical downlink shared channel, information of a transport format of the user data, that is, Downlink Control Information, user ID for carrying out communication using the physical uplink shared channel, information of a transport format of the user data, that is, Uplink Scheduling Grant or the like are reported.

Furthermore, broadcast channels such as Physical-Broadcast Channel (P-BCH) and Dynamic Broadcast Channel (D-BCH) or the like are transmitted through a downlink. Information transmitted through the P-BCH is Master Information Block (MIB) and information transmitted through the D-BCH is System Information Block (SIB). The D-BCH is mapped to the PDSCH and transmitted from the base station apparatus 200 to the mobile station 100n.

For uplinks, a physical uplink shared channel (PUSCH) shared between the mobile stations 100 and a physical uplink control channel (PUCCH) which is an uplink control channel are used. Through the above physical uplink shared channel, signals such as user data, that is, speech data and transmission data are transmitted. Furthermore, through the physical uplink control channel, precoding information for downlink MIMO transmission, delivery confirmation information for a downlink shared channel, downlink radio quality information (CQI: Channel Quality Indicator) or the like are transmitted.

Furthermore, a physical random access channel (PRACH) for initial connection or the like is defined for uplinks. The mobile station 100 transmits a random access preamble with the PRACH.

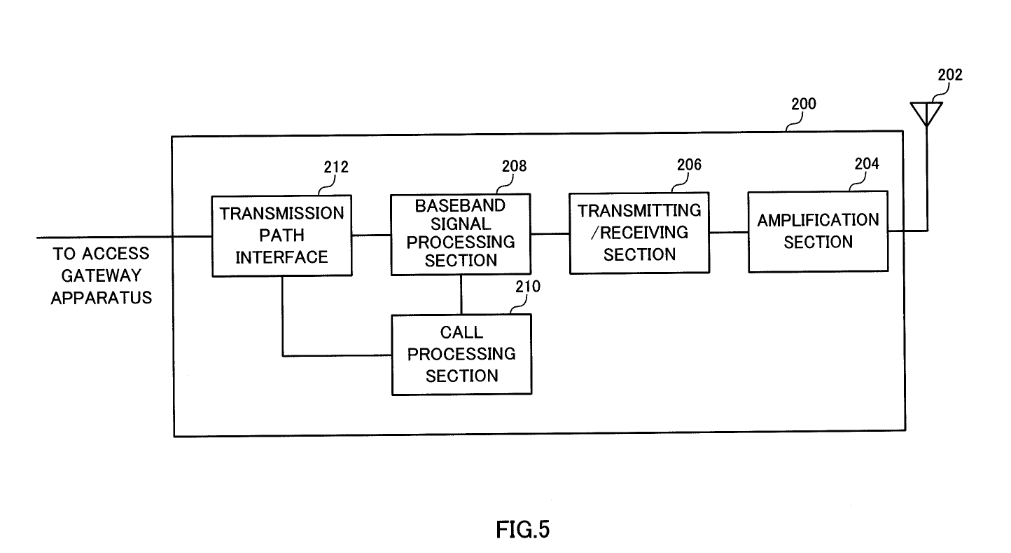

The base station apparatus 200 according to the embodiment of the present invention will be described with reference to FIG. 5. The base station apparatus 200 according to the present embodiment is provided with a transmitting/receiving antenna 202, an amplification section 204, a transmitting/receiving section 206, a baseband signal processing section 208, a call processing section 210 and a transmission path interface 212. The present invention is also applicable to MIMO transmission, but components relating to MIMO transmission are omitted in the present embodiment.

User data (speech data for speech communication or transmission data for data communication) transmitted through a downlink from the base station apparatus 200 to the mobile station 100 is inputted from a higher station positioned superior to the base station apparatus 200, for example, from the access gateway apparatus 300 to the baseband signal processing section 208 via the transmission path interface 212.

The baseband signal processing section 208 performs PDCP layer processing, user data division/connection, RLC layer transmission processing such as transmission processing of RLC (Radio Link Control) retransmission control, MAC (Medium Access Control) retransmission control, for example, transmission processing of HARQ (Hybrid Automatic Repeat reQuest), scheduling, transmission format selection, channel coding, inverse fast Fourier transform (IFFT) processing and transfers the signal to the transmitting/receiving section 206.

Furthermore, a signal (downlink control information) of the physical downlink control channel is also subjected to transmission processing such as channel coding and inverse fast Fourier transform or the like and transferred to the transmitting/receiving section 206.

Furthermore, the baseband signal processing section 208 reports control information for communication in the cell to the mobile station 100 with the aforementioned broadcast channel. The control information for communication in the cell can include, for example, a system bandwidth in an uplink or downlink, allocation information of radio resources allocated to the mobile station 100, identification information of a root sequence (Root Sequence Index) for generating a signal of a random access preamble in the PRACH.

Furthermore, the baseband signal processing section 208 reports to the mobile station 100 information on a spreading code (spreading code information) assigned to the mobile station 100 for speech communication through a downlink control channel at the start of speech communication.

The transmitting/receiving section 206 applies frequency conversion processing for converting the baseband signal outputted from the baseband signal processing section 208 to a radio frequency band, the amplification section 204 then amplifies the signal and the transmitting/receiving antenna 202 transmits the signal.

On the other hand, for data transmitted from the mobile station 100 to the base station apparatus 200 through an uplink, the amplification section 204 amplifies a radio frequency signal received by the transmitting/receiving antenna 202, the transmitting/receiving section 206 frequency-converts the signal to a baseband signal and inputs the signal to the baseband signal processing section 208.

The baseband signal processing section 208 performs FFT processing, IDFT processing, error correcting decoding, reception processing of MAC retransmission control, reception processing of the RLC layer and PDCP layer on user data included in the inputted baseband signal and transfers the processed data to the access gateway apparatus 300 via the transmission path interface 212.

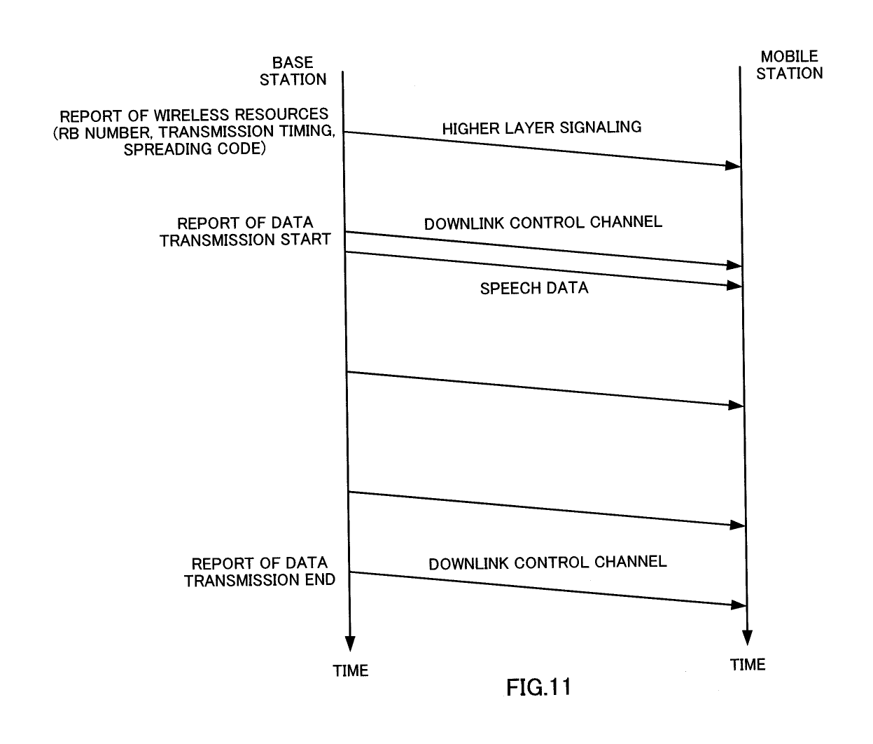

The call processing section 210 performs call processing such as setting and release of a communication channel, management of the state of the radio base station 200 and management of radio resources. The call processing section 210 repeats the securing and release of fixed radio resources based on the number of users carrying out speech communication or traffic of speech data. At the start of speech communication, radio resources made up of a predetermined pattern of resource blocks are secured at fixed time intervals as shown in FIG. 2 and the radio resources are released when speech communication ends. FIG. 11 shows an overview of a sequence from start to end of call processing. Radio resource allocation (resource block number, transmission timing, spreading code information) is reported from the radio base station 200 to the mobile station 100 through higher layer signaling. After that, the radio base station 200 reports a data transmission start (including a speech communication start) to the mobile station 100 through a downlink control channel, and data communication/speech communication starts. When ending data communication/speech communication, the end of data communication/speech communication is reported through the downlink control channel.

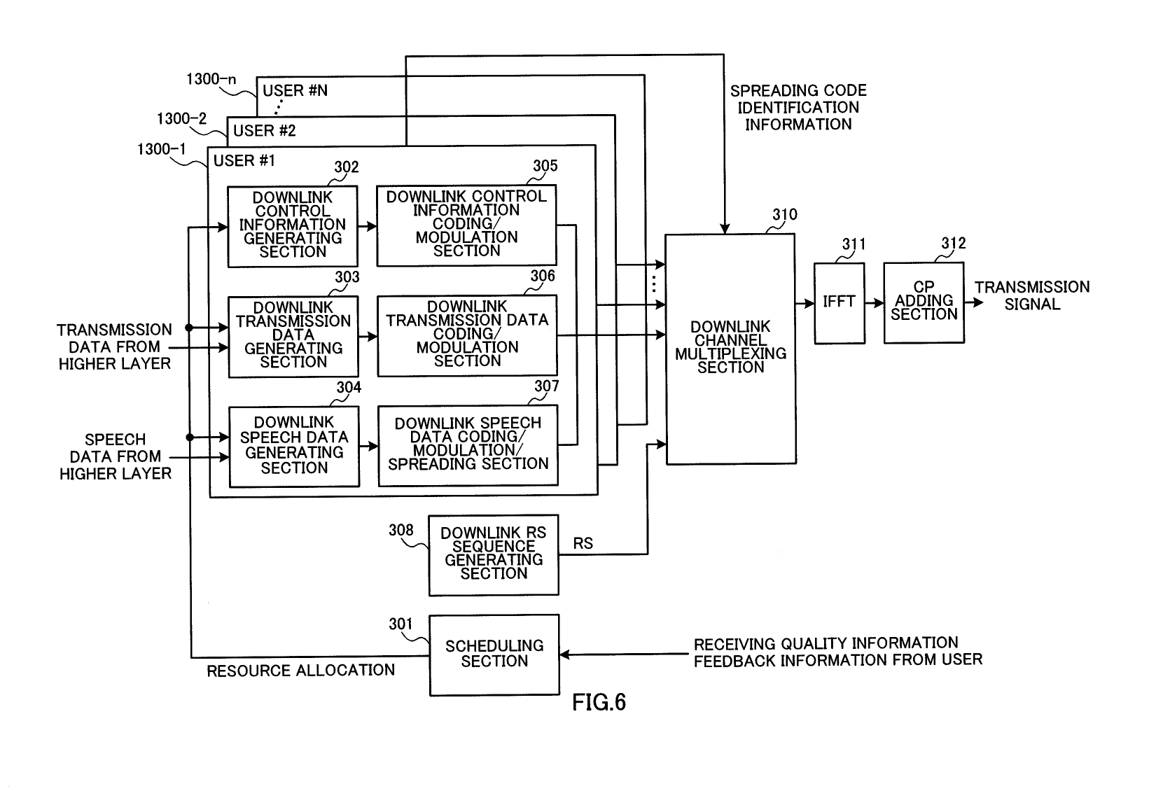

FIG. 6 is a function block diagram of the transmission processing system in the baseband signal processing section 208 of the radio base station 200. For a downlink, a scheduling section 301 allocates PDSCH radio resources in resource block units at a subframe period based on a downlink channel quality report value for each frequency block from each mobile station 100. Furthermore, for an uplink, the scheduling section 301 allocates PUSCH radio resources in resource block units based on an uplink channel quality measured value from each mobile station 100. As described above, for the mobile station 100 carrying out speech communication, without performing instantaneous radio resource allocation according to channel quality, a predetermined pattern of radio resources are secured at a predetermined period up to a predetermined number of subframes ahead at the start of speech communication, the radio resources are allocated and different spreading codes are assigned among multiplexed users. The call processing section 210 gives information for identifying the mobile station 100 that carries out speech communication to the scheduling section 301.

The baseband signal processing section 208 is provided with a plurality of processing cards 1300-1 to 1300-n corresponding in number to the number of users that can be accommodated. For convenience of explanation, when each mobile station 100 is distinguished from others, it is expressed as “user #n” instead of the “mobile station 100.” The processing card 1300-1 is provided with a downlink control information generating section 302 that generates downlink control information for user #1, a downlink transmission data generating section 303 that generates transmission data for data communication for user #1 and a downlink speech data generating section 304 that generates speech data for speech communication for user #1.

The downlink control information generating section 302 generates downlink control information including downlink/uplink scheduling information for user #1 given from the scheduling section 301. Furthermore, the downlink control information generating section 302 receives a speech communication start request from the call processing section 210 and generates information on a spreading code to be assigned to user #1. The spreading code is generated based on spreading code allocation information. The spreading code allocation information is included in scheduling information. The downlink control information generating section 302 generates spreading code information so that different spreading codes are assigned among a plurality of users carrying out speech communication simultaneously.

The downlink transmission data generating section 303 generates transmission data based on the scheduling information given from the scheduling section 301 and outputs the transmission data. When user #1 is carrying out data communication, transmission data is given from a higher layer.

The downlink speech data generating section 304 generates speech data based on the scheduling information given from the scheduling section 301 and outputs the speech data. When user #1 is carrying out speech communication, speech data is given from a higher layer.

The processing card 1300-1 is provided with a downlink control information coding/modulation section 305 that encodes and modulates the downlink control information generated by the downlink control information generating section 302, a downlink transmission data coding/modulation section 306 that encodes and modulates the downlink transmission data generated by the downlink transmission data generating section 303 and a downlink speech data coding/modulation/spreading section 307 that encodes and modulates the downlink speech data generated by the downlink speech data generating section 304 and further performs spread spectrum modulation on the downlink speech data. The downlink speech data coding/modulation/spreading section 307 generates a spreading code assigned to a target user. The downlink speech data coding/modulation/spreading section 307 performs spread spectrum modulation on the speech data (after coding and modulation) outputted from the same processing card 1300 using the spreading code. The downlink transmission data coding/modulation section 306 receives a coding rate and a modulation scheme from an AMC (Adaptive Modulation and channel Coding) control section (not shown), encodes and modulates the transmission data according to the given coding rate and modulation scheme.

The other processing cards 1300-2 to 1300-n have the same function block configuration as that of the processing card 1300-1 and are allocated for communication with other users #2 to #n.

Furthermore, the baseband signal processing section 208 is provided with a downlink RS sequence generating section 308. The downlink RS sequence generating section 308 generates an RS sequence signal having known transmission power and phase transmitted to the mobile station 100 through a reference signal. A reference signal transmitted through a downlink reference signal is transmitted to the mobile station 100 at a known frequency and time. The reference signal transmitted through the reference signal is used for measurement of downlink channel quality (CQI) in the mobile station 100, channel estimation for coherent detection of a downlink signal, cell search and estimation of the state of a downlink propagation path for handover.

A downlink channel multiplexing section 310 multiplexes a downlink control channel for transmitting the downlink control information outputted from each processing card 1300-1 to 1300-n, a shared channel for transmitting user data (transmission data, speech data), a reference signal and other necessary channels.

The downlink channel multiplexing section 310 multiplexes the transmission data and speech data transmitted through a PDSCH according to a CDM scheme as schematically shown in FIG. 1. In the case of the schematic view shown in FIG. 1, code multiplexing is applied to a plurality of users #1 to #4 carrying out speech communication simultaneously.

On the other hand, for user data other than speech data (transmission data), different resource blocks are allocated at positions not overlapping radio resources allocated to speech communication. Each processing card 1300 carrying out data communication gives transmission data generated according to scheduling information to the downlink channel multiplexing section 310. In the case of the schematic view shown in FIG. 1, radio resources are allocated to users #6 and #7 in the same subframe as speech communication and multiplexed. That is, users #6 and #7 are multiplexed according to an FDM/TDM scheme and outputted.

The downlink control information generated by the downlink control information generating section 302 is transmitted through a PDCCH. In the configuration based on an LTE system (including LTE-A system), a broadcast information generating section (MIB) (not shown) generates an MIB (Master Information Block), a broadcast information generating section (SIB) generates an SIB (System Information Block) and these pieces of broadcast information are sent through a PBCH and DBCH. The RS sequence signal generated by the downlink RS sequence generating section 308 is sent through a reference signal. The physical channel for transmitting the downlink control information, broadcast information and RS sequence signal is also channel-multiplexed by the downlink channel multiplexing section 310.

The signal channel multiplexed by the downlink channel multiplexing section 310 is subjected to inverse fast Fourier transform by the inverse fast Fourier transform section 311, and with a cyclic prefix (CP) added for each symbol, transmitted to the transmitting/receiving section 206 as a transmission signal.

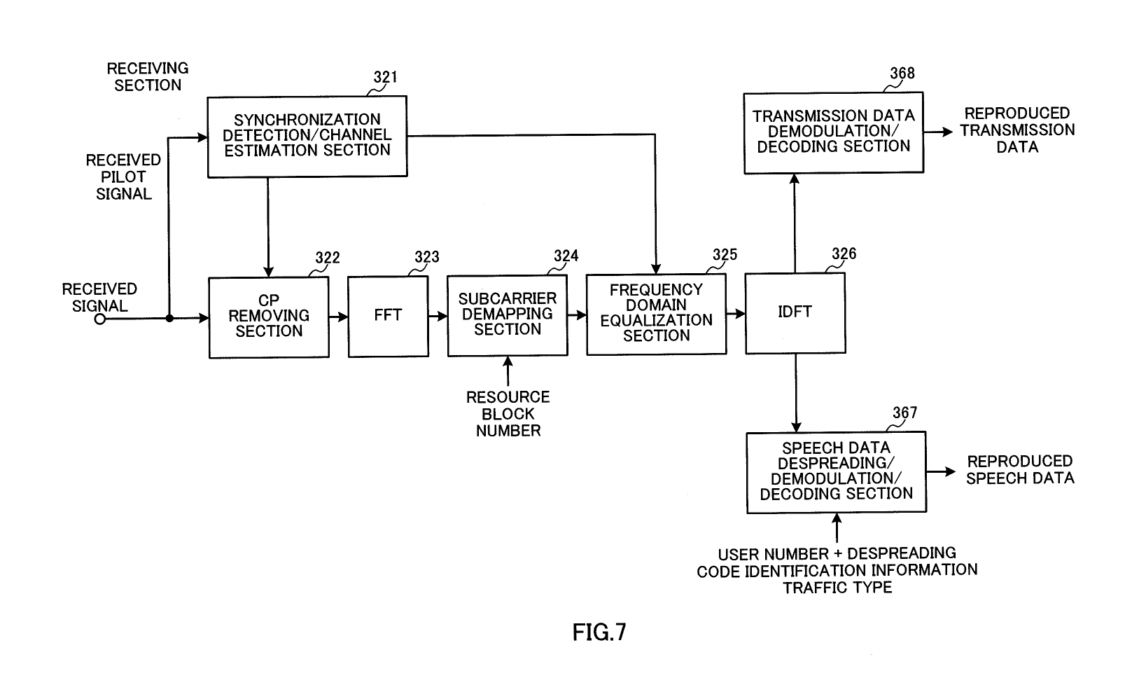

FIG. 7 is a function block diagram of the reception processing system in the baseband signal processing section 208 of the radio base station 200. A reference signal included in a received signal received on an uplink is inputted to a synchronization detection/channel estimation section 321. The synchronization detection/channel estimation section 321 estimates the channel state of the uplink based on the reception state of the reference signal received from the mobile station 100. On the other hand, the received signal inputted to the baseband signal processing section 208 is got rid of a cyclic prefix added to the received signal by a CP removing section 322, and then subjected to Fourier transform by a fast Fourier transform section 323 to be transformed into a frequency domain signal. The received signal transformed into the frequency domain signal is demapped in the frequency domain by a subcarrier demapping section 324.

The subcarrier demapping section 324 performs demapping according to radio resource information allocated to the mobile station 100 by the scheduling section 301.

A frequency domain equalization section 325 equalizes the received signal based on a channel estimate value given from the synchronization detection/channel estimation section 321. An inverse discrete Fourier transform section 326 applies inverse discrete Fourier transform to the received signal and converts the frequency domain signal back into a time domain signal. As will be described later, the mobile station 100 carrying out speech communication has spread spectrum modulated uplink speech data, and therefore the speech data needs to be despread and decoded. When the traffic type of user data transmitted through a PUSCH is “speech data,” it is inputted to a speech data despreading/demodulation/decoding section 367. On the other hand, when the traffic type is “transmission data,” it is inputted to a transmission data demodulation/decoding section 368. The speech data despreading/demodulation/decoding section 367 performs despreading processing on the speech data, performs demodulation and decoding processing and reproduces speech data. In this case, different spreading codes are assigned to different users and the mobile station 100 which is one user performs spread spectrum modulation on the speech data using a spreading code instructed from the radio base station apparatus 200. The information for identifying a despreading code for decoding the spread spectrum modulated speech data is given from the downlink control information generating section 302 to the speech data despreading/demodulation/decoding section 367 together with the user number. The speech data despreading/demodulation/decoding section 367 performs despreading processing using the generated despreading code. The transmission data demodulation/decoding section 368 performs demodulation and decoding processing and thereby reproduces the transmission data.

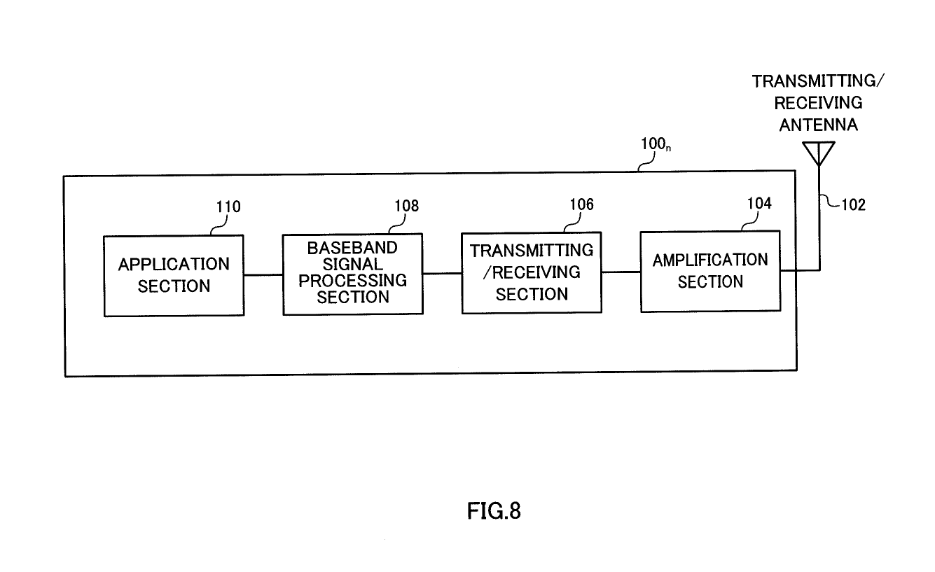

The mobile station 100 according to the embodiment of the present invention will be described with reference to FIG. 8. In FIG. 8, the mobile station 100 is provided with a transmitting/receiving antenna 102, an amplification section 104, a transmitting/receiving section 106, a baseband signal processing section 108 and an application section 110.

For the downlink data, a radio frequency signal received by the transmitting/receiving antenna 102 is amplified by the amplification section 104, frequency-converted to a baseband signal by the transmitting/receiving section 106. This baseband signal is subjected to FFT processing, error correcting decoding, reception processing of retransmission control or the like by the baseband signal processing section 108. Of the downlink data, downlink user data (speech data, transmission data) is transferred to the application section 110. The application section 110 performs processing relating to layers higher than the physical layer or MAC layer. Furthermore, of the downlink data, broadcast information is also transferred to the application section 110.

On the other hand, the uplink user data is inputted from the application section 110 to the baseband signal processing section 108. The baseband signal processing section 108 performs transmission processing of retransmission control (H-ARQ (Hybrid ARQ)), channel coding, DFT processing, IFFT processing or the like and transfers the signal to the transmitting/receiving section 106. The transmitting/receiving section 106 performs frequency conversion processing of converting the baseband signal outputted from the baseband signal processing section 108 to a radio frequency band, the amplification section 104 then amplifies the signal, which is then transmitted from the transmitting/receiving antenna 102.

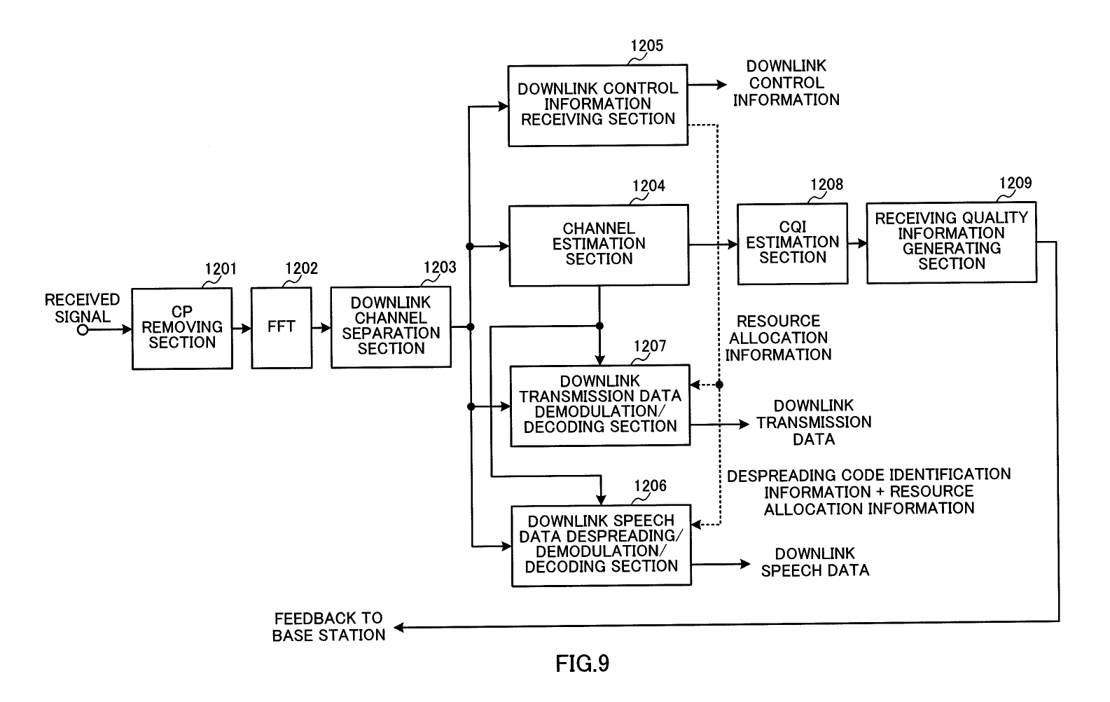

FIG. 9 is a function block diagram of the reception processing system of the baseband signal processing section 108. The received signal outputted from the transmitting/receiving section 106 is inputted to a CP removing section 1201, where a cyclic prefix is removed. A fast Fourier transform section 1202 applies fast Fourier transform to the received signal from which the CP has been removed to transform the time sequence signal component into a column of frequency components. A downlink channel separation section 1203 performs subcarrier demapping to separate the signal into a reference signal transmitting an RS sequence signal, a control channel (e.g., PDCCH) transmitting downlink control information and a shared channel (e.g., PDCCH) transmitting user data.

The reference signal is inputted to a channel estimation section 1204 and the downlink control information of the control channel is inputted to a downlink control information receiving section 1205. Furthermore, of the user data of the shared channel, the speech data is inputted to a downlink speech data despreading/demodulation/decoding section 1206 and the transmission data of the data communication is inputted to a downlink transmission data demodulation/decoding section 1207.

The channel estimation section 1204 compares the received reference signal having a channel distortion component with a known reference signal and estimates channel distortion. The estimated channel distortion information is inputted to the downlink speech data despreading/demodulation/decoding section 1206 and downlink transmission data demodulation/decoding section 1207 and used for channel equalization. Furthermore, a CQI estimation section 1208 calculates CQI from the channel distortion information given from the channel estimation section 1204 and a receiving quality information generating section 1209 generates downlink channel quality based on the CQI. The downlink channel quality is transmitted to the base station apparatus 100 through an uplink.

The downlink control information receiving section 1205 extracts downlink control information from the control channel channel-separated by the downlink channel separation section 1203. Of the downlink control information, allocation information of resources for the user is inputted to the downlink speech data despreading/demodulation/decoding section 1206 and the downlink transmission data demodulation/decoding section 1207. The downlink control information given to the downlink speech data despreading/demodulation/decoding section 1206 includes spreading code information for decoding speech data directed thereto from the speech data user-multiplexed according to a CDM scheme. When carrying out speech communication, before starting speech communication, the radio base station allocates radio resources and spreading code information to the user and indicates the spreading code information and radio resource information to the mobile station 100 through a downlink. Furthermore, when carrying out data communication, the radio base station sequentially allocates radio resources to the user until the data communication ends and radio resource information is sequentially informed to the mobile station 100 through the downlink.

The downlink speech data despreading/demodulation/decoding section 1206 receives, during speech communication, the shared channel channel-separated by the downlink channel separation section 1203. The downlink speech data despreading/demodulation/decoding section 1206 extracts speech data user-multiplexed according to a CDM scheme based on the resource allocation information given from the downlink control information receiving section 1205. On the other hand, the downlink speech data despreading/demodulation/decoding section 1206 generates a despreading code of a spreading code assigned to the user based on the spreading code information. By despreading the user-multiplexed speech data using the generated despreading code, only the speech data directed thereto is decoded. For example, according to the schematic view shown in FIG. 1, the speech data of users #1 to #4 are multiplexed with the same radio resources (time/frequency) according to a CDM scheme. Since user #1 receives the multiplexed speech data, it is possible to demodulate only the speech data directed to user #1 by performing despreading using a despreading code corresponding to the spreading code assigned to user #1. The decoded speech data is decoded and sent to a higher layer as downlink speech data.

The downlink transmission data demodulation/decoding section 1207 receives, during data communication, the shared channel channel-separated from the downlink channel separation section 1203. The downlink transmission data demodulation/decoding section 1207 extracts downlink transmission data from the shared channel based on the resource allocation information. The downlink transmission data is subjected to demodulation and demodulation processing, reproduced and then sent to a higher layer.

The mobile station 100 receives user data multiplexed according to different multiplexing schemes depending on the traffic type.

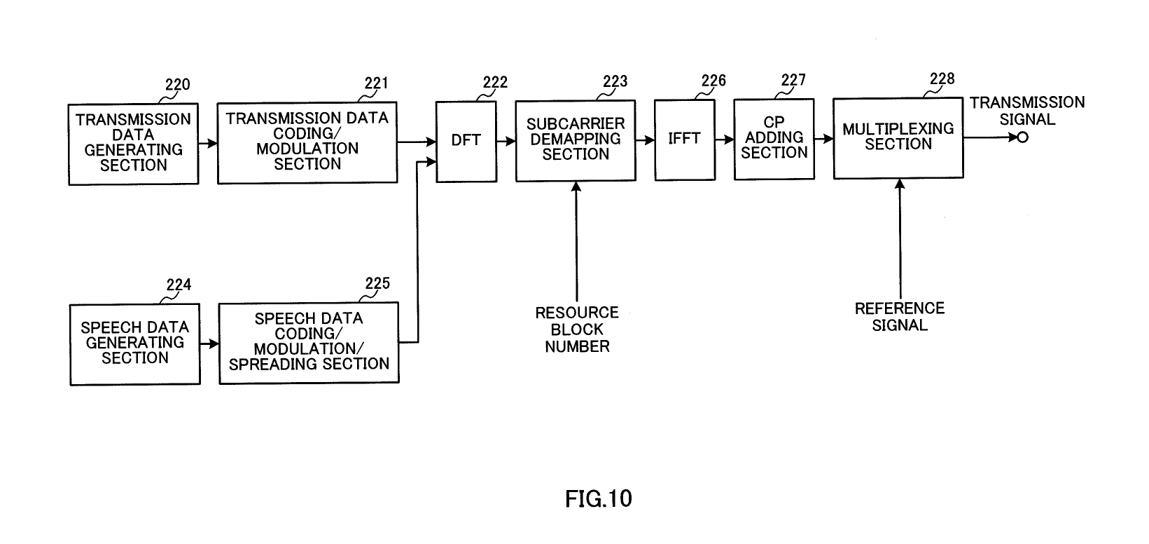

FIG. 10 is a function block diagram of the transmission processing system of the baseband signal processing section 108. The application section 110 shown in FIG. 8 sends transmission data to a transmission data generating section 220 when carrying out data communication or sends speech data to a speech data generating section 224 when carrying out speech communication.

The transmission data generating section 220 converts transmission data given from the application section 110 to a predetermined format and outputs the transmission data to a transmission data coding/modulation section 221. The transmission data encoded and modulated by the transmission data coding/modulation section 221 is subjected to discrete Fourier transform by a discrete Fourier transform section 222 to be transformed into a column of frequency components. A subcarrier mapping section 223 acquires resource allocation information allocated to the user from the downlink control information received by the downlink control information receiving section 205. The subcarrier mapping section 223 maps, when the traffic type is data communication, the transmission data to resource blocks allocated to the uplink shared channel of the user.

The speech data generating section 224 converts speech data given from the application section 110 to a predetermined format and then outputs the speech data to a speech data coding/modulation/spreading section 225. The speech data coding/modulation/spreading section 225 acquires, before starting speech communication, spreading code information allocated to the user from the downlink control information received by the downlink control information receiving section 205 and generates a spreading code from the acquired spreading code information. The speech data encoded and modulated by the speech data coding/modulation/spreading section 225 is spread spectrum modulated using a spreading code assigned to the user. The baseband processing section 108 may be provided with a traffic identification section so that the traffic identification section may identify the traffic type of the uplink user data and transmit the traffic type to the speech data coding/modulation/spreading section 225. The spread spectrum modulated speech data is subjected to discrete Fourier transform by the discrete Fourier transform section 222 to be transformed into a column of frequency components. When the traffic type is speech communication, the subcarrier mapping section 223 performs transmission processing using radio resource information allocated to speech communication. The spread spectrum modulated signal (speech data) is mapped to radio resources (subcarrier positions) allocated to speech communication.

The user data mapped to subcarriers (transmission data or speech data) in this way is subjected to inverse fast Fourier transform by an inverse fast Fourier transform section 226 to be transformed into a time sequence signal and given a cyclic prefix by a CP adding section 227. The cyclic prefix functions as a guard interval to absorb a multipath propagation delay and a difference in reception timing between a plurality of users in the base station apparatus. The signal is further multiplexed with a reference signal by a multiplexing section 228 and then sent to the transmitting/receiving section 106.

By this means, the mobile station 100 can transmit the uplink user data by switching the multiplexing scheme according to the traffic type.

In the above description, a plurality of users are user-multiplexed according to a code division multiplexing scheme for the first traffic type data and a plurality of users are user-multiplexed according to a frequency division multiplexing/time division multiplexing scheme for the second traffic type data. The present invention may also switch between the code division multiplexing scheme and frequency division multiplexing/time division multiplexing scheme for the first traffic type data to multiplex a plurality of users.

The present invention may also perform control so as to adaptively switch the application of code multiplexing with a PDSCH/PUSCH according to the situation of traffic or the like. When, for example, the amount of traffic is relatively small, the first traffic type data is user-multiplexed according to normal (specified by the LTE system) frequency division multiplexing/time division multiplexing or user-multiplexed according to the above code multiplexing when the amount of traffic increases. In this case, the radio base station apparatus monitors the amount of traffic on the downlink and/or uplink and switches, when the amount of traffic exceeds a threshold, from user multiplexing by frequency division multiplexing/time division multiplexing to user multiplexing by code multiplexing. As a result, scheduling of allocating code-multiplexed first traffic type data signal to specific RB and signaling of information about the spreading code are performed on the mobile terminal apparatus. In signaling, for example, broadcast information to be reported at a long period is reported to all users in the cell through a broadcast channel. Furthermore, broadcast information may also be individually reported to each user using a higher layer signal.

In the radio base station 200 shown in FIG. 6, for a period during which there are speech communication users, the scheduling section 301 determines, at a predetermined period, whether or not the amount of traffic (and/or the number of users) exceeds a threshold. In the case of determining that the amount of traffic does not exceed the threshold, the scheduling section 301 does not secure a predetermined pattern of radio resources at a predetermined period up to a predetermined number of subframes ahead also for a speech communication user and instantaneously allocates radio resources. The scheduling section 301 then applies, to speech communication users, frequency division multiplexing and time division multiplexing defined in the LTE system as the user multiplexing scheme relating to the second traffic type and performs multiplexing among a plurality of users. In the case of user-multiplexing speech data which is the first traffic type by applying frequency division multiplexing and time division multiplexing, the scheduling section 301 allocates different frequency resources and time resources to different users according to a normal procedure. Spreading codes are not assigned. The scheduling information (frequency resources/time resources) allocated to each user is given to each processing card 1300 corresponding to each user. When the first traffic type is downlink speech data, the downlink speech data coding/modulation/spreading section 307 maps the downlink speech data to frequency resources and/or time resources according to the scheduling information. In this case, since the resource allocation information does not include the spreading code allocation information, speech data which is the first traffic type is not code-spread. The downlink speech data outputted from the downlink speech data coding/modulation/spreading section 307 is multiplexed by the downlink channel multiplexing section 310 and transmitted. On the other hand, the downlink control information generating section 302 receives scheduling information on the downlink speech data from the scheduling section 301. As described above, until the amount of traffic exceeds a threshold, the scheduling section 301 instantaneously allocates radio resources for frequency division multiplexing/time division multiplexing to each user (including a speech communication user). Therefore, the downlink control information generating section 302 sequentially generates downlink control information for transmitting scheduling information on speech data which is the first traffic type to the user as in the case of the second data type data. The downlink control information generating section 302 may also include information indicating that the speech data which is the first traffic type is frequency division multiplexed/time division multiplexed and transmitted as in the case of the second traffic type in the downlink control information. Control information (scheduling information) of the downlink speech data is sent through a PDCCH.

Furthermore, upon determining that the amount of traffic exceeds the threshold, the scheduling section 301 secures a predetermined pattern of radio resources for each speech communication user carrying out speech communication at that point in time at a predetermined period up to a predetermined number of subframes ahead and gives scheduling information including the radio resource information secured for each speech communication user to each processing card 1300 corresponding to the speech communication user. Even in the middle of speech communication, the user multiplexing method is switched at a point in time at which the amount of traffic exceeds the threshold. For this reason, signaling of resource allocation information (a predetermined pattern of radio resources secured at a predetermined period and spreading code) allocated to each speech communication user is performed on the mobile terminal apparatus. Furthermore, when the amount of traffic ceases to exceed the threshold in the middle of speech communication, the user multiplexing method may be switched from that point in time (actually including the time for preparations for switching) from code multiplexing to frequency division multiplexing/time division multiplexing.

In the mobile station 100 in FIG. 9, the downlink control information receiving section 1205 extracts downlink control information from the control channel channel-separated by the downlink channel separation section 1203. Of the downlink control information, resource allocation information for the user is inputted to the downlink speech data despreading/demodulation/decoding section 1206 and the downlink transmission data demodulation/decoding section 1207. When the downlink speech data is frequency division multiplexed/time division multiplexed, the downlink control information given to the downlink speech data despreading/demodulation/decoding section 1206 includes the radio resource information allocated to the speech communication user. Even when speech communication is carried out, if downlink speech data is frequency division multiplexed/time division multiplexed among a plurality of users because the amount of traffic is relatively low, the radio base station sequentially allocates radio resources to the speech communication user and sequentially indicates radio resource information to the mobile station 100 through a downlink.

The downlink speech data despreading/demodulation/decoding section 1206 receives a shared channel channel-separated by the downlink channel separation section 1203. The radio base station apparatus extracts speech data directed thereto from the user-multiplexed data based on the resource allocation information given from the downlink control information receiving section 1205. When the speech data is frequency division multiplexed/time division multiplexed, the resource allocation information includes no spreading code information, and it is therefore not necessary to despread the received signal.

Furthermore, in the radio base station 200, the scheduling section 301 controls resource allocation to the first traffic type data on the uplink of each user. In this case, when the amount of traffic does not exceed a threshold, radio resources are also allocated so that a plurality of users carrying out speech communication are frequency division multiplexed/time division multiplexed. Uplink resource allocation information (uplink scheduling information) for frequency division multiplexing/time division multiplexing for each user is transmitted to each mobile station 100 via a downlink. On the other hand, when the amount of traffic exceeds the threshold, as described above, a predetermined pattern of radio resources are secured for the speech communication user up to a predetermined number of subframes ahead at a predetermined period and a spreading code is assigned to each user so that a plurality of users carrying out speech communication are code division multiplexed. The uplink resource allocation information (a predetermined pattern of radio resources at a predetermined period up to a predetermined number of subframes ahead and spreading code information) allocated to each speech communication user for code division multiplexing of uplink speech data is transmitted to each mobile station 100 which is a speech communication user as uplink scheduling information via a downlink. A multiplexing method switching signal may be included in the uplink scheduling information for a speech communication user. The speech communication user can switch the multiplexing method according to a switching signal included in the uplink scheduling information received through a downlink. However, the speech user need not be aware of multiplexing of speech data with other users and needs only to map speech data to radio resources indicated by the uplink scheduling information.

In the mobile station 100 in FIG. 9, the downlink control information receiving section 1205 extracts uplink scheduling information from a control channel channel-separated by the downlink channel separation section 1203 and gives the uplink scheduling information to the transmission system shown in FIG. 10. When the speech data is frequency division multiplexed/time division multiplexed among users, uplink speech data is encoded and modulated by the speech data coding/modulation/spreading section 225, but is not spread spectrum modulated using a spreading code, and is therefore mapped according to the uplink scheduling information by the subcarrier mapping section 223. Furthermore, when the uplink speech data is code division multiplexed among a plurality of users, the uplink speech data is spread spectrum modulated by the speech data coding/modulation/spreading section 225 using a spreading code included in the uplink scheduling information. After that, the subcarrier mapping section 223 maps the uplink speech data to radio resources according to uplink scheduling information (frequency resources fixedly allocated up to a plurality of subframes ahead).

The present invention is not limited to the aforementioned embodiments, but can be implemented with various changes without departing from the spirit and scope of the present invention.

### INDUSTRIAL APPLICABILITY

The present invention is applicable to a radio communication system in which a first traffic type to which a predetermined pattern of radio resources are periodically allocated and a second traffic type to which available radio resources are sequentially allocated are mixed, multiplexed and transmitted through a downlink.

The present application is based on Japanese Patent Application No. 2009-011346 filed on Jan. 21, 2009 and Japanese Patent Application No. 2009-183692 filed on Aug. 6, 2009, entire content of which is expressly incorporated by reference herein.

1. A radio communication control method comprising:
a step of allocating first radio resources to first traffic type data at a predetermined period and in a predetermined pattern and sequentially allocating available second radio resources to second traffic type data;
a step of code division multiplexing the first traffic type data among a plurality of users and frequency division multiplexing and time division multiplexing the second traffic type data among a plurality of users; and
a step of transmitting the multiplexed data.

2. A radio communication control method comprising:
a step of receiving first resource allocation information on radio resources allocated to first traffic type data at a predetermined period and in a predetermined pattern, and spreading code information assigned to a user, through a downlink;
a step of sequentially receiving second resource allocation information on available radio resources sequentially allocated to second traffic type data, through the downlink;
a step of separating, when the data received through the downlink is the first traffic type, the received data based on the first resource allocation information and despreading the separated data based on the spreading code information to demodulate; and
a step of separating, when the data received through the downlink is the second traffic type, the received data based on the second resource allocation information.

3. A radio communication control method comprising:
a step of receiving first resource allocation information on radio resources allocated to first traffic type data at a predetermined period and in a predetermined pattern and spreading code information assigned to a user through a downlink;
a step of sequentially receiving second resource allocation information on available radio resources sequentially allocated to second traffic type data, through the downlink;
a step of spread spectrum modulating, when data transmitted through an uplink is the first traffic type, the first traffic type data based on the spreading code information and mapping the spread spectrum modulated signal at predetermined positions in a frequency domain based on the first resource allocation information; and
a step of mapping, when data transmitted through an uplink is the second traffic type, the second traffic type data at predetermined positions in a frequency domain based on the second resource allocation information.

4. The radio communication control method according to claim 1, further comprising:
a step of separating the first and second traffic type data from a received signal received through an uplink based on information on the first and second radio resources; and
a step of despreading and decoding, when the separated received data is a first traffic type, the received data using a despreading code corresponding to the spreading code assigned to a transmission user of the received data.

5. The radio communication control method according to claim 1, wherein the first traffic type is fixed-speed and low-rate traffic.

6. The radio communication control method according to claim 1, wherein the first traffic type is speech communication and the second traffic type is data communication.

7. The radio communication control method according to claim 2, wherein before starting transmission/reception of the first traffic type data, the first resource allocation information and spreading code information are indicated from a radio base station apparatus via a downlink, and when the second traffic type data is transmitted/received, the second resource allocation information is sequentially indicated from the radio base station apparatus via the downlink.

8. The radio communication control method according to claim 1, wherein available radio resources are sequentially allocated to the first and second traffic type data until an amount of traffic exceeds the threshold, first radio resources are allocated at a predetermined period and in a predetermined pattern to the first traffic type data when the amount of traffic exceeds the threshold and available second radio resources are sequentially allocated to the second traffic type data, and the first and second traffic type data are frequency division multiplexed and time division multiplexed among a plurality of users until the amount of traffic exceeds the threshold.

9. A radio communication control method comprising:
a step of receiving first resource allocation information on radio resources allocated to first traffic type data at a predetermined period and in a predetermined pattern, and spreading code information assigned to users through a downlink;
a step of sequentially receiving any one of second resource allocation information on available radio resources sequentially allocated to second traffic type data and third resource allocation information on available radio resources sequentially allocated to the first and second traffic type data, through the downlink;
a step of separating, when the data received through the downlink is the first traffic type and if the first resource allocation information is received as resource allocation information of the first traffic type data, the downlink received data based on the first resource allocation information, and despreading and demodulating the separated data based on the spreading code information;
a step of separating, when the data received through the downlink is the second traffic type, the received data of the downlink based on the second resource allocation information; and
a step of separating, when the data received through the downlink is the first and second traffic type and if the third resource allocation information is received as the resource allocation information of the first and second traffic type data, the received data of the downlink based on the third resource allocation information.

10. A radio base station apparatus comprising:
a resource allocating section configured to allocate first radio resources to first traffic type data at a predetermined period and in a predetermined pattern and sequentially allocate available second radio resources to second traffic type data;
a multiplexing section configured to perform code division multiplexing the first traffic type data among a plurality of users and frequency division multiplexing and time division multiplexing the second traffic type data among a plurality of users; and
a transmitting section configured to transmit the multiplexed data.

11. A user apparatus comprising:
a downlink control information receiving section configured to receive first resource allocation information on radio resources allocated to first traffic type data at a predetermined period and in a predetermined pattern and spreading code information assigned to a user, through a downlink, and receive second resource allocation information on available radio resources sequentially allocated to second traffic type data, through the downlink; and
a mapping section configured to perform spread spectrum modulating, when data transmitted through an uplink is the first traffic type, the first traffic type data based on the spreading code information, map the spread spectrum modulated signal at a predetermined position in a frequency domain based on the first resource allocation information and map, when data transmitted through the uplink is the second traffic type, the second traffic type data at a predetermined position in a frequency domain based on the second resource allocation information.

12. The radio communication control method according to claim 2, wherein the first traffic type is fixed-speed and low-rate traffic.

13. The radio communication control method according to claim 3, wherein the first traffic type is fixed-speed and low-rate traffic.

14. The radio communication control method according to claim 4, wherein the first traffic type is fixed-speed and low-rate traffic.

15. The radio communication control method according to claim 2, wherein the first traffic type is speech communication and the second traffic type is data communication.

16. The radio communication control method according to claim 3, wherein the first traffic type is speech communication and the second traffic type is data communication.

17. The radio communication control method according to claim 4, wherein the first traffic type is speech communication and the second traffic type is data communication.

18. The radio communication control method according to claim 5, wherein the first traffic type is speech communication and the second traffic type is data communication.

19. The radio communication control method according to claim 3, wherein before starting transmission/reception of the first traffic type data, the first resource allocation information and spreading code information are indicated from a radio base station apparatus via a downlink, and when the second traffic type data is transmitted/received, the second resource allocation information is sequentially indicated from the radio base station apparatus via the downlink.

20. The radio communication control method according to claim 5, wherein before starting transmission/reception of the first traffic type data, the first resource allocation information and spreading code information are indicated from a radio base station apparatus via a downlink, and when the second traffic type data is transmitted/received, the second resource allocation information is sequentially indicated from the radio base station apparatus via the downlink.

21. The radio communication control method according to claim 6, wherein before starting transmission/reception of the first traffic type data, the first resource allocation information and spreading code information are indicated from a radio base station apparatus via a downlink, and when the second traffic type data is transmitted/received, the second resource allocation information is sequentially indicated from the radio base station apparatus via the downlink.
